(19) United States
(12) Patent Application Publication
(10) Pub. No.: US 2006/0200401 A1
(43) Pub. Date: Sep. 7, 2006

(54) Online descending bid auction

(75) Inventors: Gil Lisani, Bat-Yam (IL); Sharon Birnbaum, Tel-Aviv (IL); Guy Cohen, Bat-Yam (IL)

Correspondence Address: PEARL COHEN ZEDEK, LLP, 1500 BROADWAY 12TH FLOOR, NEW YORK, NY, 10036, US

(73) Assignee: BIG TRADE ELECTRONICS LTD.

(21) Appl. No.: 11/069,547

(22) Filed: Mar. 2, 2005

(51) Int. Cl. G06Q 40/00

(52) U.S. Cl. 705/37

(57) ABSTRACT

An online descending bid auction for selling an item to clients on a network. A server on the network announces a starting price for the item and the duration of the auction, then proceeds to decrement the price at intervals of the remaining time and present the new price to the clients, the size of the decrements or the intervals or both characterized such that the clients cannot predict the them. The clients bid by indicating acceptance of the current price. If a bid is received before the end of the auction time, the bidder is optionally checked to verify that he or she has not previously bid for this particular item already. If the check is positive the bid is accepted and the item goes to that client. Optionally, for a predetermined length of time, the clients can then purchase more units of the item at the accepted bid price.

### FIELD OF THE INVENTION

The present invention relates to distribution of services or products through an auction. More particularly it relates to an online descending bid auction where the price decrement and/or interval between decrements cannot be predicted.

### BACKGROUND OF THE INVENTION

This invention concerns descending bid auctions, which are also referred to as Dutch auctions. The term Dutch auction is also commonly used to refer to another type of auction where bidders with winning bids are allowed to pay the price paid by the winning bidder with lowest bid. To avoid confusion, the term descending bid auction is used in this disclosure.

In a descending bid the “auctioneer” starts with a quote which is usually more than the expected price for the item. If there is no bid, the quote is decreased by a fixed amount at fixed interval, until a bid is received or the quote falls below the seller-specified minimum amount. If there is a bid, the bidder takes the item for the bid amount.” (source: Paul Ezhilchelvan and Graham Morgan, “A Dependable Distributed Auction System: Architecture and an Implementation Framework”, Proceedings of the 5th International Symposium on Autonomous Decentralized Systems (ISADS 2001), IEEE Computer Society Press 2001 (URL: http://www.cs.ncl.ac.uk/research/pubs/inproceedings/papers/218.pdf)).

Online systems for auctioning are well known in the art. An example of an auction web site is eBay Corporation's web site (URL: http://www.ebay.com). Another example is provided by Ezhilchelvan and Morgan in their paper, which describes a distributed system for Internet-based on-line auctions.

To further illustrate the design of prior art online descending bid auctions, consider an example where a boat is auctioned. Bidders (buyers) visiting the auction site view information regarding when the auction will start, how long it will last, and the starting quote, say $2200. The seller sets a reserve price, say $1000, which is not necessarily displayed to the bidders.

At the designated time the auction starts and the auction clock starts counting down the time. The price goes down a predetermined amount at predetermined intervals. In the boat example, assume that the auction time is set to last for ten minutes and the auction price is set to decrement by $2 per second. In that case, the auction price goes down $120 per minute or $1200 over the ten minutes of the auction (unless the auction is stopped first by a buyer accepting the current price).

In many cases the prior art descending bid auction includes more than one item, in which case the auction continues until all the items are sold—unless time runs out. In the boat example, assume that five of the boats are for sale. Assume that after five minutes the price has gone down $600 to $1600. A bidder (buyer) decides that he wants the boat and “bids” (signals his agreement to buy) at $1600. The boat has now been sold to that bidder. Since four boats remain and five minutes remain on the clock, the auction continues. After another three minutes, the price is now $1240. Another buyer takes a boat at this price and since two minutes remain, the auction continues. This dynamic continues until the remaining three boats are sold or the remaining two minutes are used up—whichever comes first.

A first problem in prior art descending bid auctions can occur when multiple instances of an item are auctioned. In that case, a given buyer can take a first such item at a relatively high price as “insurance”, take a second such item when the price goes lower, and then cancel his bid for the first such item By taking the first such item at the earlier, higher price, the buyer ensures that he has the item while being able to cancel enables him to try to better his purchase by catching a lower price for the item. This defeats the purpose of the seller, which is to sell as many units as possible, at the highest possible price.

A preferred embodiment of the present invention alleviates this first problem by restricting the auction to one item where “item” in this context means either a single unit or an indivisible block of units of a product or service.

If a seller wants to offer more than one item, a set (series) of auctions is performed, where one item (again, meaning either a single unit or indivisible block of units) is sold per auction in the set.

In an alternative embodiment, when a sale is made (thereby ending the auction), buyers are permitted for a predefined period of time to purchase more of the item (i.e., more units or blocks of units) at the sale price (per unit or multiplied by the number of units in the block).

In another alternative embodiment, buyers are restricted to one bid per item. In other words, once a buyer has made a bid, he cannot purchase in any remaining auctions in the set for that item.

A second problem in prior art descending bid auctions is that the price goes down a fixed amount at fixed intervals to a fixed reserve price. This predictability can help a buyer to improve his strategy for bidding lower. For example, since the buyer sees the auction clock and the change in the price, once a few decrements have been made to the starting price, the buyer can easily determine the decrement amount and the interval. Since the length of the auction is also displayed, the buyer can then determine the reserve price by calculating: reserve=decrement X interval X length. By deducing the reserve price, the buyer can better gauge when to bid.

The present invention alleviates this second problem by making variable the auction parameter values, particularly the amounts the price is decremented and the intervals of time between the decrements.

In summary, it is a main object of the present invention to provide a descending bid auction to online potential buyers connected to the auction via a network such as the Internet or interactive television, the auction consisting of a set of one or more auctions for a given item, the “item” comprising a single unit or an indivisible block of units of a product or service, where each auction in the set ends with a sale at the first buyer's bid, the bid comprising the buyer's assent to purchase the item at the current auction price..

It is another main object of the present invention to, once a sale has occurred, to enable buyers for a predefined period of time to buy additional items at the sale price.

It is another main object of the present invention to, once a bidder has bid for an item, optionally continue lowering the price on any remaining like items but prohibit that bidder from further bidding.

It is another main object of the present invention to provide an automated descending bid auction that requires from a seller only definitions for the quantity of items and the reserve price.

It is another main object of the present invention to restrict a purchaser to one purchase of an item per set of auctions, irregardless of whether the buyer cancels his purchase.

It is another main object to vary the amount by which the auction price is decremented over the length of the auction and/or the intervals between the decrements.

### BRIEF DESCRIPTION OF THE INVENTION

There is thus provided in accordance with a preferred embodiment of the present invention, a method for an online auction for selling an item over a network with a plurality of clients, the method comprising.
providing a server connected to the network for managing the auction, the managing of the auction comprising:
   setting a starting price for the item;
   lowering the price from the starting price over a predetermined period of time in a plurality of decrements, characterized in that the clients or users at the clients cannot anticipate the amount of the decrements or the time intervals between decrements or both, and presenting a currently offered price to the clients;
   upon receiving, within the predetermined period of time, a first acceptance indication from a client indicating that a current price is accepted by the client or a user at the client, selling the item to the client or the user at the client who generated the indication at a sale price that is the price currently offered when the indication is received;
   and wherein if no acceptance indication is received within the predetermined period of time the auction ends without the item being sold.

Furthermore, in accordance with another preferred embodiment of the present invention, lowering of the price is restricted to remain above a reserve price.

Furthermore, in accordance with another preferred embodiment of the present invention, the reserve price is unknown to the clients or users at the clients.

Furthermore, in accordance with another preferred embodiment of the present invention, the amount of at least some of the decrements, the length of at least some of the time intervals between the decrements, or both is determined randomly..

Furthermore, in accordance with another preferred embodiment of the present invention, upon closing the auction when a first acceptance indication was received, at least one item identical to the sold item is offered at the same sale price for a predetermined period of time to clients or users at the clients.

Furthermore, in accordance with another preferred embodiment of the present invention, a client or a user that buys the item at the currently offered price is prohibited from buying the same item in at least one future auction.

Furthermore, in accordance with another preferred embodiment of the present invention, upon receiving the first acceptance indication the auction is closed.

Furthermore, in accordance with another preferred embodiment of the present invention, upon receiving the first acceptance indication, another item is offered with a starting price that is the currently offered price, the price being lowered in the decrements for the remainder of the predetermined period of time.

Furthermore, in accordance with another preferred embodiment of the present invention, the predetermined period of time is presented to the clients..

Furthermore, in accordance with another preferred embodiment of the present invention, the remaining amount of the predetermined period of time is presented to the clients.

There is thus also provided in accordance with a preferred embodiment of the present invention, a computer software product for an online auction for selling an item over a network with a plurality of clients, comprising a computer-readable medium having computer program instructions recorded therein, which instructions, when executed by one or more processors on a server connected to the network, cause the one or more processors to carry out the steps of:
managing the auction, the managing of the auction comprising:
   setting a starting price for the item;
   lowering the price from the starting price over a predetermined period of time in a plurality of decrements, characterized in that the clients or users at the clients cannot anticipate the amount of the decrements or the time intervals between decrements or both, and presenting a currently offered price to the clients;
   upon receiving, within the predetermined period of time, a first acceptance indication from a client indicating that a current price is accepted by the client or a user at the client, selling the item to the client or the user at the client who generated the indication at a sale price that is the price currently offered when the indication is received;
   and wherein if no acceptance indication is received within the predetermined period of time the auction ends without the item being sold.

There is thus also provided in accordance with a preferred embodiment of the present invention, a system for an online auction for selling an item over a network with a plurality of clients, the system comprising:
a server connected to the network for managing the auction, the managing of the auction comprising:
   setting a starting price for the item;
   lowering the price from the starting price over a predetermined period of time in a plurality of decrements, characterized in that the clients or users at the clients cannot anticipate the amount of the decrements or the time intervals between decrements or both;
   upon receiving, within the predetermined period of time, a first acceptance indication from a client, indicating that a current price is accepted by the client or a user at the client, selling the item at the currently offered price to the client or the user at the client that generated the first acceptance indication
   and wherein if no acceptance indication is received within the predetermined period of time the auction ends without the item being sold.

### BRIEF DESCRIPTION OF THE FIGURES

The invention is described herein, by way of example only, with reference to the accompanying Figures, in which like components are designated by like reference numerals.

FIG. 1 is a block diagram of an example of an online auction environment in which the present invention may operate.

FIG. 2 is a block diagram of an auction server constructed in accordance with the present invention.

FIG. 3 is a flowchart summarizing a method for providing descending bid online auction services in accordance with the present invention.,

FIG. 4 is an exemplary web page for a descending bid online auction in accordance with the present invention.

FIG. 5 is a table showing an exemplary descending bid auction sequence anc corresponding auction status information..

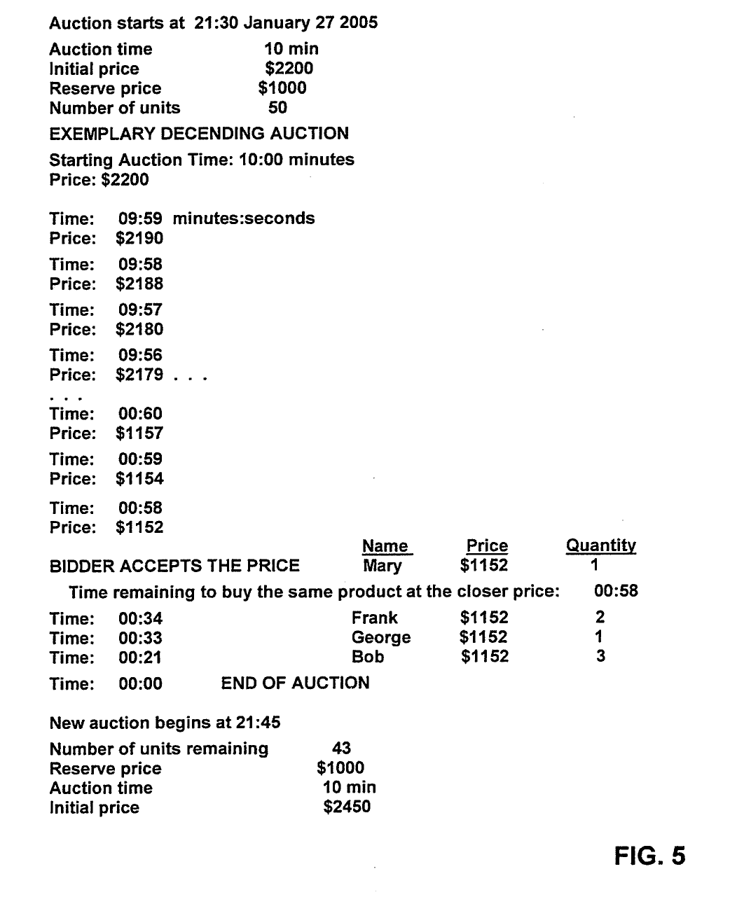

### DETAILED DESCRIPTION OF THE INVENTION

The present invention provides an improved descending bid online auction.

In the context of this disclosure the term “item” refers to one or more units of a product or service where, in the case of more than one unit, all the units are sold as a single indivisible block of units.

In the descending bid auction of the present invention, an online auction site offers one or more instances or an “item” for sale. The auction lasts a predefined time and starts with a price that is decremented at intervals, where the decrement amount and interval length cannot be predicted by a bidder, and where a bidder can bid at any time to indicate his acceptance of the price at the time of his bid. The auction ends when either a bidding condition is met (explained later in this description) or the auction time runs out.

In a preferred embodiment of the present invention the bidding condition is the first bid of the first bidder for a single instance of the item (again, where “item” is a unit or an indivisible block of units). If the seller is offering more than a single instance of the item, then a set (series) of auctions is performed with one auction per instance of the item.. Thus, for example, if a seller had five boats to sell, the present invention could perform five auctions: one per boat; two auctions: one for an indivisible block of four boats and one for a single boat, or a similar arrangement.

In an alternative embodiment of the present invention, when the auction ends, an additional period of time begins wherein buyers are permitted to purchase one or more instances of the item but at the final auction price (which is either the sale price if there was a bid or the reserve price if no bid was received and time ran out). This prevents a buyer from bidding for a first “insurance” unit and then canceling the bid after bidding for a second, lower priced unit since there is only one price for all the units in the auction.. If any units remain after this period of time, then another auction starts for one or an indivisible group of those units, and so forth.

In another alternative embodiment, buyers are restricted to one bid per item. In other words, once a buyer has made a bid, he cannot purchase in any remaining auctions in the set for that item. Even if he cancels his bid, he cannot participate again in that auction set. Therefore, the buyer cannot pursue the strategy of grabbing an “insurance” unit with the intention of canceling it once he has a cheaper unit. In this embodiment an auction can comprise more than one “item” (where each “item” comprises one unit or an indivisible block of units), in which case once a buyer bids, if items remain, the auction continues (price continues to be decremented by the auction site) but that bidder is no longer allowed to bid.

In a preferred embodiment of the present invention, variable values are provided for the auction parameters, particularly for the amounts the price is decremented and the intervals of time between the decrements In a preferred embodiment of the present invention, these varying values are generated done automatically by the auction software, although they could also be determined in part or in whole by the seller or the auction site owner. Other auction parameters are optionally variable including the length in time of the auction, the starting price, and the reserve price (which can be varied for each auction in a set).

Preferably the descending bid auction of the present invention is automated, requiring a seller only to provide the quantity of item units for sale and the reserve price as well as preferably providing a description that may include text and/or visual representations and a reserve price.

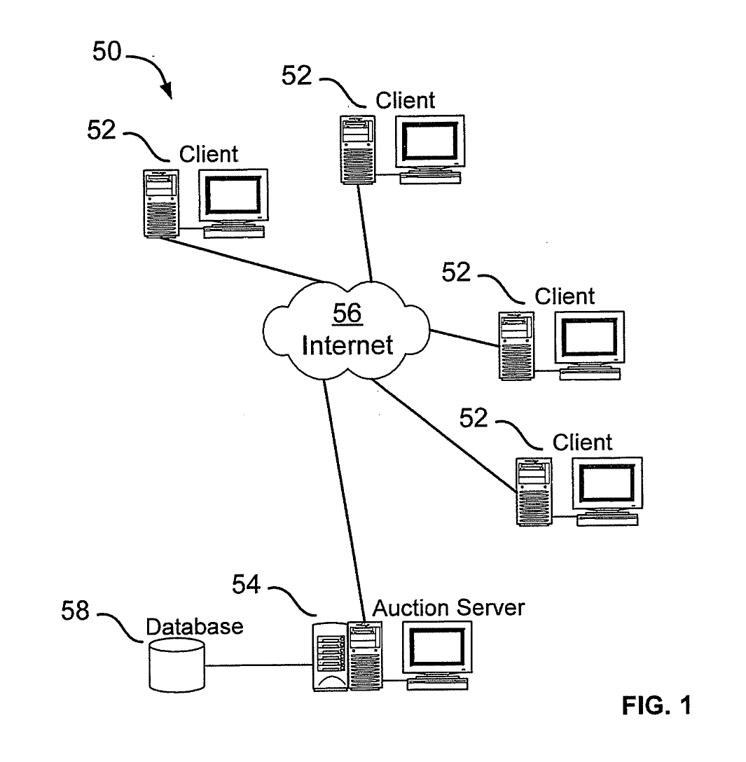

FIG. 1 is a block diagram of an example of an online auction environment 50 in which the present invention may operate. One or more clients computing devices 52 operated by potential auction buyers and sellers are communicatively connected to at least one auction server computing device 54 via a network 56, such as the Internet or an intranet. Auction server 54 can store data about buyers, sellers, and items for sale in database 58, which is kept in a permanent memory, which could be an internal hard drive or an external computing device.

One or more auction servers 54 may establish and manage an online descending bid auction. Prior to an auction, auction server 54 makes accessible to client systems 52 descriptive information about the item (product or service) that is for sale as well as auction-related information including the starting price of the item and starting time (and date), and time allotted for the auction. At the starting time auction server 54 starts the auction clock. The price declines in steps and both the clock reading and the current price are made accessible to client systems 52 until either the clock runs out (allotted time over) or a buyer uses a client system 52 to effect a purchase (agreeing to pay the price at the time of the purchase), whichever comes first The general system and methods for effecting descending bid online auctions are known to those skilled in the art.

During the online descending bid auctions, the present invention provides services for improving the auctions, as is described in detail later in this disclosure.

A client system 52 comprises a computing device, such as a personal computer or workstation, with network connectivity. More specifically, a client system 52 may include a processing unit; an input subsystem such as a keyboard or a mouse; an output subsystem such as a graphics unit and display; a data storage such as a hard drive; a network connectivity unit, such as a modem or a network card, for connecting to the Internet or another network; and a memory wherein operating and browsing software can be held. A buyer system can also be used by a seller to set up an auction.

It should be noted that client system 52 can equally be implemented in an interactive television, which contains the required elements.

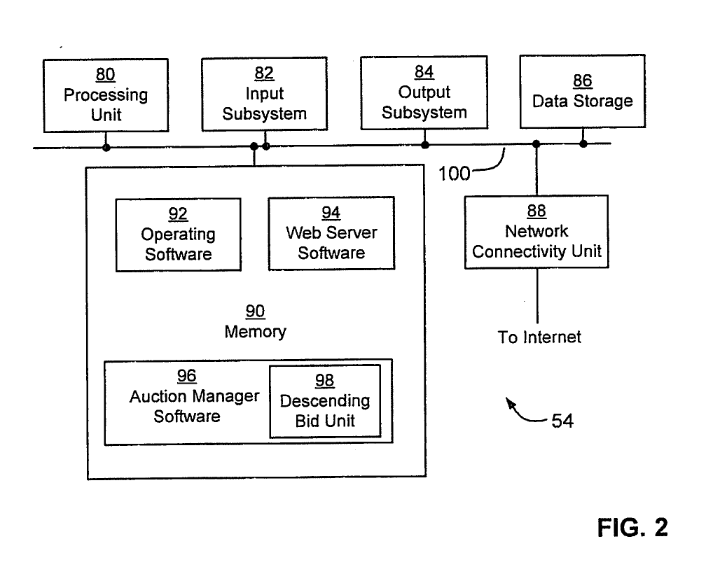

FIG. 2 is a block diagram of an auction server 54 constructed in accordance with the present invention. In one embodiment, auction server 54 comprises a computing device having a processing unit 80; an input subsystem 82 such as a keyboard or a mouse; an output subsystem 84 such as a display; a data storage 86 such as a hard drive; a network connectivity unit 88, such as a modem or a network card, for connecting to the Internet or another network; and a memory 90 holding operating software 92, web server software 94, and auction manager software 96. All parts of auction server 54 are connected to a common bus 100.

Processing unit 80 comprises a microprocessor capable of executing stored program instructions. Input subsystem 82 comprises circuitry for controlling input devices (for example a keyboard controller) and for performing signal conversions (for example, a digital signal processor) upon input data. Output subsystem 84 comprises circuitry for operating upon and outputting data for display, for example a video card with processor, frame buffer, and display driver. Data storage unit 86 may include both fixed and removable media based on storage technology such as magnetic, optical, or magneto-optical devices. Network connectivity unit 88 includes hardware and software for data communication in accordance with conventional protocols.

Memory 90 includes both random access memory (RAM) and read-only memory (ROM), and provides storage for program instructions and data. Within the memory 100, operating software 92 comprises program instruction sequences for accessing, communicating with, and/or controlling auction server resources Operating software 92 provides a software platform upon which application programs may execute, in a manner readily understood by those skilled in the art. Those skilled in the art will also understand that web server software 94 comprises program instruction sequences for responding to messages received via the Internet or other network. Finally, auction manager 96 comprises program instruction sequences for establishing and managing online auctions. In one embodiment, auction manager 96 includes a descending bid unit 98 that facilitates or supports descending bid auctions, in a manner described in detail later in this disclosure In an exemplary embodiment of the present invention, auction server 54 is a computing device having at least one Intel Pentium IV (Intel Corporation, Santa Clara, Calif.) microprocessor; 2048 megabytes of random access memory (RAM); an internal hard disk drive and redundant drive; and at least one modem or network interface card. Microsoft Windows™ (Microsoft Corporation Redmond, Wash.) may serve as operating software 92 with Microsoft Internet Information Server™ serving as web server software 94, all of which are well understood by those skilled in the art.

For any given auction, auction manager 96 can verify sellers and buyers; determine and bill any seller or buyer fees; communicate with the seller to receive from the seller the auction parameter values and update the seller about the auction status and result; communicate with the buyers regarding new auctions and auction status or results, and generally perform online auction management tasks, as is readily understood by those skilled in the art

In the context of the present invention, a descending bid auction initiated by a seller using a client system 52 comprises a message that may include the parameter values in the following list. All these parameters are optional and can equally be provided auction manager 96 or the auction site manager. Generally the seller will provide information about the item, the number of instances, and his reserve price. In cases where a range is supplied as a parameter value, auction manager 96 randomly selects a value within the range.
1) Seller identification (ID) that uniquely identifies the seller corresponding to the client system 52.
2) Description of the item for sale, which could include pricing information such as the retail price, and a photograph of, or relating to, the item.
3) Quantity of units of the item for sale (in which case a set of auctions will be performed, the set comprising one auction per unit). In an alternative preferred embodiment of the present invention, if a purchase is made, buyers are given an opportunity to buy additional units at the purchase price for a limited time before the next auction in the set (or the end of the set). In that embodiment, the final number of auctions in a set will be a function of how many items remain after these opportunities,
3) Starting auction price, which could be a single value, a range for the set, or individual values/ranges for each auction in the set.
4) Date and time preference for the auction.
5) Length of the auction (duration), which could be a single value, a range for the set or individual values/ranges for each auction in the set.
6) Length of the interval between auctions in a set.
7) Reserve price, which could be a single value, a range for the set, or individual values/ranges for each auction in the set.
8) Quantity to decrement periodically from the price and the rate (period) at which to do so, where both parameter values could be a single value, a range for the set, or individual values/ranges for each auction in the set.
   In a preferred embodiment, the decrement quantity is calculated automatically by auction manager 96. The constraint of the decrement calculation is that the price at the end of the auction time period (assumes no bids, therefore no premature completion of the auction) will have descended to the reserve price.
   A general decrement D1 can therefore be calculated as:
      D1=(opening price−reserve)/length of auction (sec)
   There are many known algorithms in the art that take D1 and generate a set of random or partially random values that will subtract to the reserve price. By way of example, one is provided below:
      a) Maintain internal calculation of the “constraint price”, which is what the price would be each second were D1 applied consistently as the decrement quantity.
      b) generate random values for actual decrements where actual decrement values are confined within a predetermined range and subject to the constraint that the actual price always be within a predefined quantity from the constrain price of step (b).

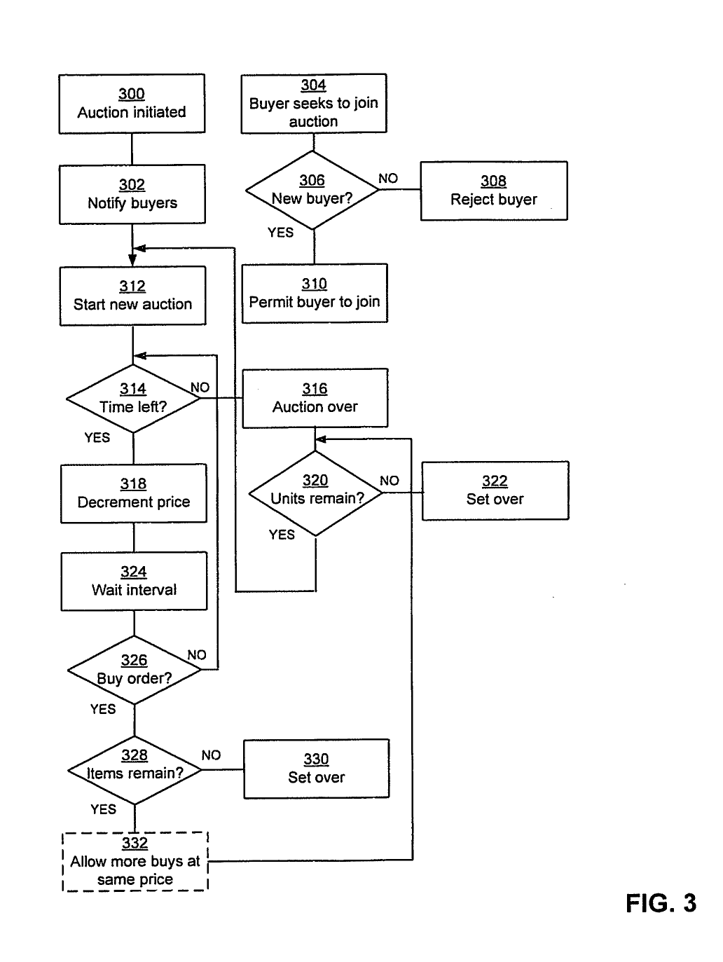

FIG. 3 is a flowchart summarizing a method for providing descending bid online auction services in accordance with the present invention. In a preferred embodiment, the method begins in step 300 with an auction manager 96 receiving a descending bid auction request from a seller on a client system 52 who is registered with auction manager 96, where the request preferably includes at least the identification of the new auction item; if the item is a block, then the number of instances in the block; the quantity of items; the seller's reserve price; and descriptive content about the item.

In step 302, auction manager 96 assigns a time and date for the auction and communicates that information together with a description of the sale item, and optionally other information such as the starting price, to potential buyers who are registered with auction manager 96. Typically this will take the form of adding this information to listings on an auction web site maintained by web server software 94 and can also be done using various technologies such as e-mail notification, RSS (really simple syndication) feed, web advertising, print advertising, and the like.

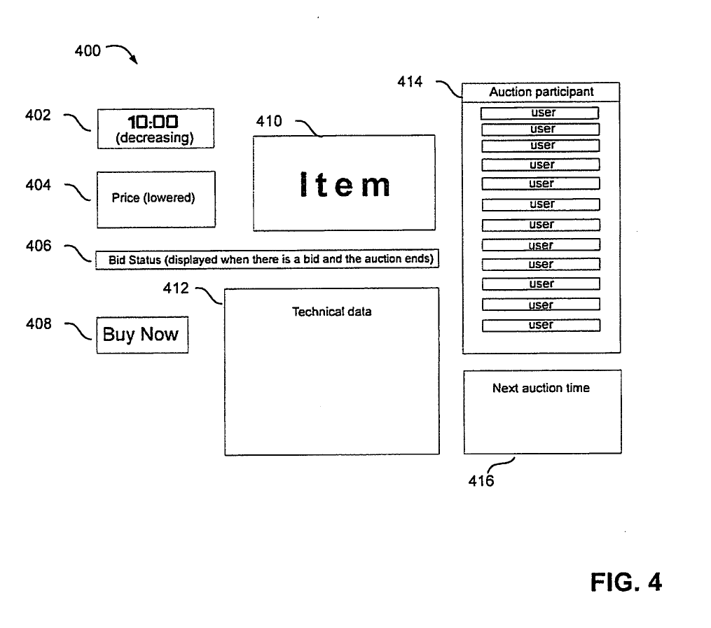

In step 304, auction manager 96 starts the auction of an item at the appointed time and date, by sending to client systems 52 of buyers a page that is updated as necessary throughout the auction set. An exemplary page 400 is shown in FIG. 4. Auction clock 402 is set to a predetermined start time and counts down towards zero. Price 404 starts with a predetermined price and is continuously decremented for the duration of the auction Bid status 406 displays whether a buyer has accepted the current price, thereby ending the auction or changing the auction to final buy state, as is described later in this method description. Buy button 408 is a control whereby a buyer can indicate his willingness to buy at the current price. Product photo 410 is a photo of, or representative of, the auction item. Technical information 412 is a description of the auction item. Buyer list 414 lists participants (accepted buyers).

In step 306, auction manager 96 checks the clock to verify that time remains.

If no time is left, auction manager 96 ends the auction (step 308) and proceeds to step 320 (described later in this description). If however there is time remaining in the auction, auction manager 96 decrements the price 310 (preferably with a random decrement), and waits an interval 312 (preferably a random interval) between increments, such that the buyers cannot predict the reserve price. (Alternatively, interval 312 precede decrement 310)

Auction manager 96 checks (316) whether a bidder has placed a bid (meaning the bidder accepts the current price). If no, it returns to step 306. If yes, it checks whether the bidder is new—meaning that the bidder has not already bid on any instance of this item in this auction set. If no, it returns to step 306. If yes, it accepts the bid 318.

Auction manager 96 then proceeds to check 320 whether instances of the item remain unsold or whether the set of auctions executed is within a predetermined limit. If no, the set is over 322. If yes, it checks 324 whether time remains in the auction. If no, it starts a new auction 304 for the next instance of the item. If yes it goes to step 314, however in this case the price of the current auction has now been set as the price accepted by the first bidder and now for a predetermined period bidders can buy additional instances of the item at the acceptance price set by the first bidder.. In this case, step 316 is not applied.

FIG.. 5 is a table showing an exemplary descending bid auction bidding sequence and corresponding auction status information. In the exemplary bidding, sequence, 50 instances of an item are offered for sale as individual units (some or all could have been offered as a block of units), the auction manager 96, with or without input from the seller or the auction site owner, has determined a starting time and date, that the auction will last 10 minutes, and that it will start at $2200, This information is communicated to the bidders. The auction manager 96, with or without input from the seller or the auction site owner, has also determined that the reserve price will be $1000—so if no units are bought, meaning that the auction runs to the full ten minutes, the price will be $1000 at the very last second and that the intervals between decrements in the price will all be one second. The reserve price is used only by the auction manager 96 and is not communicated to the bidders. Similarly, the length of the intervals between decrements is not communicated to the bidders.

The auction opens at the starting price of $2200 with 10.00 minutes on the clock. One second later, auction manager 96 decreases the price by $10 decrement to $2190. Each such decrement, the resulting price, and the auction clock time are communicated to the buyers. One second later auction manager 96 decreases the price by $2 to $2188. The next decrement is $8 to $2180 followed by $1 to $2179. (The figure does not show each of the 600 decrements (10 minutes×60 sec/min.)

By the time 60 seconds are remaining, the price has decreased to $1157, 1 second later it decreases another $3 to $1154. The next second, at 58 seconds till expiration of the auction, the price drops a further $2 to $1152. At the point the bidder Mary activates a control on her client computing device 52 indicating her desire to purchase the item at the current price of $1152.

Auction manager 96 looks up Mary's buying record in database 58 and verifies that she has not bid in the current set of auctions (of which this is the first in the set) Therefore, auction manager 96 accepts Mary's bid, ending the bidding (and the decrementing of the price). Since there are 49 units remaining, auction manager 96 could optionally start a new auction for the second unit. In this example however, auction manager 96 is configured according to an alternative preferred embodiment of the present invention and for the remaining auction time of 58 seconds (or optionally for a different period time) allows any bidder to purchase additional units of the item at Mary's price of $1152. After another 24 seconds elapse, a time=34 seconds remaining, Frank activates a control on his client computing device 52 indicating his desire to take two units, which, after he is verified as not having bid in this set of auctions, are charged to him at Mary's price of $1152.

One second later George similarly orders 1 unit at Mary's price. And 12 seconds later Bob similarly orders $1152.

The clock winds down to 0 without further purchases. Since 43 units of the item remain unsold, auction manager 96 initiates a new auction, with a new initial price of $2450, the same duration of 10 minutes and the same (hidden) reserve price of $1000. The non-hidden information is distributed to potential bidders on the network and 5 minutes later, at 21.45, the new auction begins.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A method for an online auction for selling an item over a network with a plurality of clients, the method comprising:
providing a server connected to the network for managing the auction, the managing of the auction comprising:
setting a starting price for the item;
lowering the price from the starting price over a predetermined period of time in a plurality of decrements, characterized in that the clients or users at the clients cannot anticipate the amount of the decrements or the time intervals between decrements or both, and presenting a currently offered price to the clients;
upon receiving, within the predetermined period of time, a first acceptance indication from a client indicating that a current price is accepted by the client or a user at the client, selling the item to the client or the user at the client who generated the indication at a sale price that is the price currently offered when the indication is received;
and wherein if no acceptance indication is received within the predetermined period of time the auction ends without the item being sold.

2. The method of claim 1, wherein lowering of the price is restricted to remain above a reserve price..

3. The method of claim 2, wherein the reserve price is unknown to the clients or users at the clients.

4. The method of claim 1, wherein the amount of at least some of the decrements, the length of at least some of the time intervals between the decrements, or both is determined randomly.

5. The method of claim 1, wherein upon closing the auction when a first acceptance indication was received, at least one item identical to the sold item is offered at the same sale price for a predetermined period of time to clients or users at the clients.

6. The method of claim 1, wherein a client or a user that buys the item at the currently offered price is prohibited from buying the same item in at least one future auction.

7. The method of claim 1, wherein upon receiving the first acceptance indication the auction is closed.

8. The method of claim 1, wherein upon receiving the first acceptance indication, another item is offered with a starting price that is the currently offered price, the price being lowered in the decrements for the remainder of the predetermined period of time.

9. The method of claim 1, wherein the predetermined period of time is presented to the clients.

10. The method of claim 1, wherein the remaining amount of the predetermined period of time is presented to the clients.

11. A computer software product for an online auction for selling an item over a network with a plurality of clients, comprising a computer-readable medium having computer program instructions recorded therein, which instructions, when executed by one or more processors on a server connected to the network, cause the one or more processors to carry out the steps of:
managing the auction, the managing of the auction comprising:
setting a starting price for the item;
lowering the price from the starting price over a predetermined period of time in a plurality of decrements, characterized in that the clients or users at the clients cannot anticipate the amount of the decrements or the time intervals between decrements or both, and presenting a currently offered price to the clients;
upon receiving, within the predetermined period of time, a first acceptance indication from a client indicating that a current price is accepted by the client or a user at the client, selling the item to the client or the user at the client who generated the indication at a sale price that is the price currently offered when the indication is received;
and wherein if no acceptance indication is received within the predetermined period of time the auction ends without the item being sold.

12. A system for an online auction for selling an item over a network with a plurality of clients, the system comprising:
a server connected to the network for managing the auction, the managing of the auction comprising:
setting a starting price for the item;
lowering the price from the starting price over a predetermined period of time in a plurality of decrements, characterized in that the clients or users at the clients cannot anticipate the amount of the decrements or the time intervals between decrements or both;
upon receiving, within the predetermined period of time, a first acceptance indication from a client, indicating that a current price is accepted by the client or a user at the client, selling the item at the currently offered price to the client or the user at the client that generated the first acceptance indication
and wherein if no acceptance indication is received within the predetermined period of time the auction ends without the item being sold.
